(19) United States
(12) Patent Application Publication
(10) Pub. No.: US 2003/0076296 A1
(43) Pub. Date: Apr. 24, 2003

(54) Computer mouse

(76) Inventor: Derek J. Kolybaba, Edmonton (CA)

Correspondence Address: DONALD V. TOMKINS, C/O MILLER THOMSON LLP, 2700, 10155 - 102 STREET, EDMONTON, AB, T5J 4G8, CA

(21) Appl. No.: 10/274,172

(22) Filed: Oct. 21, 2002

(30) Foreign Application Priority Data
Oct. 22, 2001 (CA) 2,359,867

(51) Int. Cl. G09G 5/00

(52) U.S. Cl. 345/156; 345/163

(57) ABSTRACT

A computer mouse, for controlling the position of a cursor on a computer screen, has a main body with a cursor-positioning element and one or more switches for sending signals to a computer. The invention provides for the mouse to be mounted or worn on either the palm side or back side of the user's hand, with the cursor-positioning element and switches being operable with the hand on which the mouse is being worn, or by the user's free hand. This enables the user to wear the mouse while entering data using the computer's keyboard, and to operate the mouse while keeping both hands in close proximity to the keyboard. The invention also provides for the main body of the mouse to be articulated in two or more sections, thus permitting adjustment to enhance the user's comfort and convenient access to the cursor-positioning element and switches.

### FIELD OF THE INVENTION

The present invention relates to cursor-pointing devices for controlling the position of a cursor on a computer screen, and in particular to such devices which may be held in or on the hand and which may be operated without having to be rested upon or manipulated over a working surface.

### BACKGROUND OF THE INVENTION

Cursor-positioning devices can be used to move a cursor to a desired position on a computer screen, to select text or graphics, to choose commands, or to operate other computer functions. One widely-used type of cursor-positioning device, commonly referred to as a “mouse”, consists of a main body which many manipulated across a working surface such as a desktop or a “mousepad”. Common types of mouse incorporate a cursor control element called a “trackball” which protrudes through an opening in the bottom of the mouse and comes in contact with the working surface. The trackball is free-floating, and therefore rotates as the mouse is manipulated across the working surface. Mechanisms inside the mouse detect the physical movements of the mouse, and electronic components translate these physical movements into electronic signals which are communicated to the computer to control the position of the cursor on the computer screen.

A computer mouse may different types of control element, such as a trackball which is positioned so that it may be manipulated by the thumb or fingers rather than by being moved across a working surface. With other types of trackball, the manipulations or movements of the trackball are detected by optical or electronic means, rather than mechanical means as is common for trackballs which move across a working surface. Some computer mouse models also include a scroll wheel which can be rotated to move the cursor without physical movement of the mouse, while still having a trackball which may be moved across a working surface as the user may wish.

A conventional computer mouse has a left (or “enter”) button and a right button. Pressing the left or right button is commonly referred to as a “left click” or a “right click”, respectively. Various computer functions can be controlled by pressing these buttons, depending on the position of the cursor and the software being run by the computer. In particular, a “double left click” is used for a very large-variety of computer commands, and some types of mouse have the additional convenient feature of a third button which may be clicked a single time to generate the same effect as a “double left click”.

Despite the considerable variety of computer “mice” currently known and available on the market, a number of practical problems and drawbacks still exist. Typical operation of a computer involves data entry using the computer keyboard, combined with operation of the mouse. One problem with most known types of mouse is that in order to use the mouse, the user has to move one hand an appreciable distance away from the keyboard, thus interrupting the data entry process and generally making the operation of the computer less efficient. Another problem is that it is not always convenient or desirable to have a working surface over which to operate the mouse. A further problem with known types of mouse is that the shape of the mouse is fixed, requiring the user to adapt to that shape. This characteristic may cause discomfort or inconvenience for some users, whose hands may not adapt well to the shape of the mouse, even when the mouse is of so-called ergonomic design.

The prior art illustrates various examples of attempts to advance the state of the art of the computer mouse. Canadian Patent Application No. 2,397,500 (Dufeu et al.), filed on Jan. 18, 2001, describes a hand-held thumb-controlled trackball mouse. The Dufeu device is held in the user's hand while the user uses his or her thumb to manipulate a trackball mounted on the top of the device. Buttons mounted on the bottom of the device may be activated with the fingers. Although the Dufeu device does not require a working surface, it still requires the user to move one of his or her hands from the keyboard in order to use it. In addition, the Dufeu device must be held in the user's hand with the trackball up and the buttons down, which may not provide ideal positioning of the trackball and buttons for all users.

U.S. Pat. No. 5,668,574 (Jarlance-Huang), issued on Sep. 16, 1997, describes a palm-top wireless trackball mouse. The Jarlance-Huang device is held in the user's hand while the user manipulates a trackball with the thumb. Like the Dufeu device, the Jarlance-Huang device does not require a working surface, but does require the device to be repeatedly picked up and put down for normal operation of a computer. In addition, the Jarlance-Huang device must be held in the user's hand on the palm side, providing only a limited number of accessible positions for the trackball and the input keys.

Accordingly, there is a need for a computer mouse that provides improved versatility with respect to manipulation of the trackball, switches, or other computer control elements, to suit a user's needs or preferences and enhance the user's comfort, while at the same time avoiding the need for a working surface in order to operate the mouse. In addition, there is a need for a computer mouse which may be mounted or worn on a user's hand such that it may be operated with a reduced requirement for movement of the user's hands away from the computer keyboard. The present invention is directed to these needs.

### BRIEF SUMMARY OF THE INVENTION

In general terms, the present invention in one aspect is a computer mouse that may be worn on the user's hand, with cursor control means (such as a trackball) and switches which in one embodiment may be operated using the digits of either hand. The invention allows the user to type at a computer keyboard while wearing the mouse, and to operate the mouse with minimal movement of either hand away from the keyboard.

In a second aspect, the invention is a computer mouse with a main body having two (or more) sections connected to each other in articulated fashion, such that the sections may be adjusted and configured to suit different users' comfort and convenience. In different embodiments, the cursor control means (such as a trackball) and switches for this mouse may be mounted in a variety of positions to suit different user preferences.

Accordingly, in one aspect the present invention is a computer mouse comprising:

(a) a main body;

(b) a mounting strap connected to the main body, said mounting strap being adapted for receiving at least one digit of a user's hand, such that the user interface may be removably mounted onto the user's hand;

(c) control elements including cursor control means and one or more switches, said cursor control means and one or more switches being mounted in association with 0the main body;

(d) electronic circuitry electrically connected to the control elements, said electronic circuitry including means for generating input signals corresponding to manipulations of the control elements;

(e) signal transmission means, for transmitting the input signals to the computer; and

(f) an electrical power source.

In the preferred embodiment, the mounting strap is connected to the main body at a first point near the tail end thereof, with the other end being connected at a second point closer to the head end of the main body. The mounting strap may be made of any suitable flexible material including cloth, plastic, or rubber. It may be desirable for the selected material to be elastic so as to allow for greater adjustability and snugness of fit, but this is not essential. What is essential is that the mounting strap be of such construction and size as to allow a user to insert one hand, or to insert one or more of the digits of one hand, between the strap and the main body, such that the cursor positioning device may be removably mounted onto the hand.

In the preferred embodiment, the mounting strap is connected to the upper portion of the main body, such that the main body will be positioned under the palm of the user's hand when the user has inserted the fingers of his or her hand, palm down, into the space between the mounting strap and the main body. The cursor control means will be mounted in the main body so as to be conveniently accessible by the user's thumb when the user's hand is positioned as described above. The switch or switches will be mounted in the main body so as to be conveniently accessible by the thumb or one or more fingers of the user's hand.

Various other configurations are possible without departing from the essential concept of the present invention. In one alternative embodiment, the mounting strap may be connected to the lower portion of the main body, such that the main body will overlie the back of the user's hand when the user has inserted the fingers of his or her hand, palm down, into the space between the mounting strap and the main body. The shape of the main body, and the positions of the cursor control means and the switches, would be adapted as appropriate so that the user would have convenient access thereto.

Because it can be mounted or “worn” on the user's hand, the computer mouse of the present invention allows the user to work at a computer keyboard without having to move his hand away from the keyboard to manipulate the cursor control means or the switches, as must be done when using a conventional computer mouse that must be manipulated over a working surface, or when using hand-held mouse that does not mount on the user's hand. Reaching motions by a computer user are thus reduced when using the present invention, thereby reducing the risk of strain or injury to the arm, wrist, elbow, and shoulder.

Although the computer mouse of the present invention permits operation of the control elements using the digits of the hand on which the mouse is being worn, it will be readily appreciated that the control elements may be operated by the user's “free” hand as well.

In a second aspect, the present invention is a computer mouse comprising:

(a) a main body having a head section and a tail section, said head section and tail section being articulatably interconnected;

(b) control elements including cursor control means and one or more switches, said cursor control means and one or more switches being mounted in association with the main body;

(c) electronic circuitry electrically connected to the control elements, said electronic circuitry including means for generating input signals corresponding to manipulations of the control elements;

(d) signal transmission means, for transmitting the input signals to a computer; and

(e) an electrical power source.

The subdivision of the main body into two (or more) sections allows the user to manipulate the sections into selected positions for convenient and comfortable access to the cursor control element and switches. The head section of the main body may be swivellable relative to the tail section about a longitudinal axis of the tail section. As well, the head section may be articulated about two axes relative to the tail section. The cursor control means and switches, in different embodiments, may be mounted in a wide variety of configurations. For instance, all of these components could be mounted in the head section. Alternatively, at least one of these components could be mounted in the head section, with one or more other of these components being mounted in the tail section.

In either aspect of the present invention, the main body may be of any convenient shape. The upper and lower surfaces of the main body may be curviform such that they merge together, or said upper and lower surfaces may be substantially planar with intervening side surfaces or end surfaces. The main body will preferably be ergonomically designed to adapt comfortably to the shape of a user's hand, with smoothly rounded transitions between surfaces.

The cursor control means may be any of several devices well known in the art of the invention, including but not limited to:

a “track ball” comprising a round ball rotatably mounted in a track ball holder;

a “mini-joystick” controller;

a “mushroom hat” controller;

a “touch pad” controller; or

a “disc controller”.

The cursor control means will include means for detecting manipulations thereof by the user. The means for detecting such manipulations may be electronically, mechanically, or optically actuated.

One of the switches may be an “enter” switch having the function of the “left click” button on a conventional computer mouse. One of the switches may have the function of the “right click” button on a conventional mouse. A further switch may be provided which may be clicked once to generate a signal corresponding to a “double click” of the “enter” switch.

In the preferred embodiment, the control elements will also include a scroll wheel of a type well known in the art, whereby the user may manipulate the scroll wheel to move the cursor in a particular axis. The scroll wheel will preferably by mounted in the main body near the head end thereof, in a position conveniently accessible to the user's fingers or thumb.

The signal transmission means may be a hard-wired connection from the electronic circuitry to the “mouse” port of the computer. In this embodiment, the electrical power source will be power available from the computer, and the power connection will be a wired connection provided in conjunction with said connection to the “mouse port” of the computer. A “mouse port” includes any connection on the computer that can be adapted to receive signals from a mouse, including serial, “game”, “PS/2”, universal serial bus (USB), and “IEEE 1394” or “firewire” ports.

Alternatively, the signal transmission means may be a wireless transmitter connected to the circuitry, and capable of transmitting cursor control signals and switch signals to an appropriate signal receiver associated with the computer. The wireless transmitter may transmit the signals in any of several well-known modes, such as radio, microwave, or infrared. In this embodiment, the electrical power source will be a battery, which may be rechargeable.

The computer mouse of the present invention may also include a charger connection mounted in the main body, for connection to a battery charger. The charger connection may be of a type compatible with a cradle-type charger, in which case the main body will be adapted to fit within a cradle-type charger.

In an alternative embodiment, the cursor positioning device of the present invention may include a junction box having one or more “mouse ports” plus a connection to the “mouse port” of the computer. The junction box allows more than one mouse to be used in conjunction with each other for controlling the same computer and switch functions.

In a further alternative embodiment, the control elements include a touch screen display mounted on the main body. Using this embodiment of the invention, a user may send signals or commands to the computer by contacting selected areas on the touch screen display using a finger or a suitable stylus. This operation would be carried out using the user's free hand.

In yet a further embodiment, the computer mouse of the present invention incorporates a voice control system including a microphone. Using the voice control system, the user may give voice commands to the computer without using the control element or the switches. In a particular variant of this embodiment, the computer mouse also includes sound reproduction means, which may be a speaker, or perhaps a jack for an earphone or headphones. This allows the user to receive audible messages from the computer. For example, the user might wish to instruct the computer to read out any electronic mail that may have been received. The user would send a corresponding voice command to the computer, and would then hear an aural recitation of the electronic mail through the speaker or earphone (presuming, of course, that the computer in question has requisite capabilities). This function would be particularly useful in conjunction with the wireless embodiment of the invention, so that a user could have the benefit of numerous computer functions when the user is not in the immediate vicinity of the computer being controlled by the invention. Similar benefits could also be achieved by other variants without departing from the fundamental principles of the present invention.

### BRIEF DESCRIPTION OF THE DRAWINGS

Embodiments of the invention will now be described with reference to the accompanying figures, in which numerical references denote like parts, and in which:

FIG. 1 is a perspective view of the preferred embodiment of the invention.

FIG. 2 is a further perspective view of the preferred embodiment.

### DETAILED DESCRIPTION OF THE PREFERRED EMBODIMENT

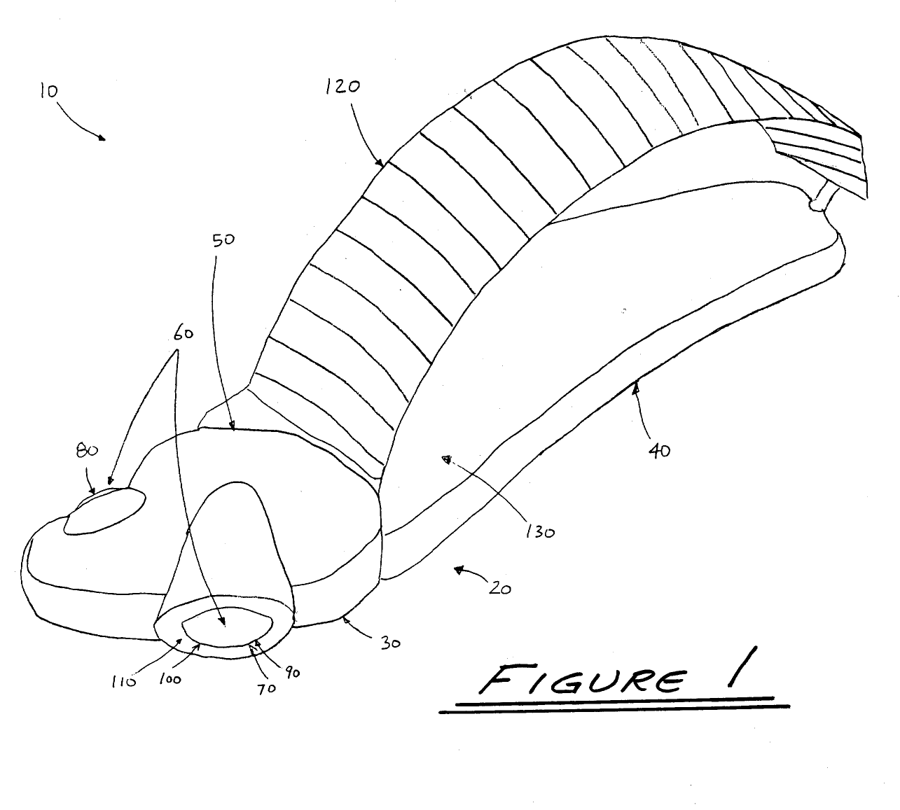

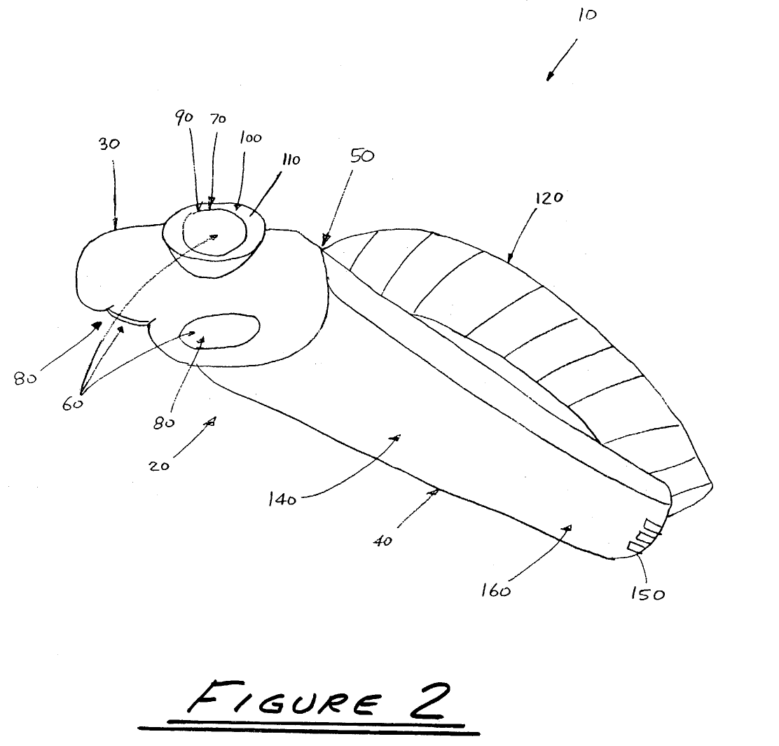

Referring to FIGS. 1 and 2, the computer mouse of the present invention, generally represented by reference numeral 10, comprises a main body 20, which in the preferred embodiment comprises a head section 30 and a tail section 40, which are interconnected such that they may be articulated relative to each other at joint 50. The mouse 10 also comprises control elements 60, including cursor control means 70 and one or more switches 80. The cursor control means 70 may be any well known control device including a “mini-joystick” controller, a “mushroom hat” controller, or a “disc controller”. In the preferred embodiment, the cursor control element 70 is a “track ball” apparatus 90 comprising a round ball 100 rotatably mounted in a track ball holder 110.

In the preferred embodiment, the electronic circuitry (not shown) is mounted in the main body 20 and electrically connected to the control elements 60, and includes means for generating input signals corresponding to manipulations of the control elements 60. The signal transmission means (not shown), transmits the input signals to the computer. In the preferred embodiment, the signal transmission means is a wireless transmitter mounted in the main body 20. In the preferred embodiment, the electrical power source (not shown) is a battery mounted in the main body 20.

A mounting strap 120, may be attached to the main body 20, said mounting strap being adapted for receiving at least one digit of a user's hand, such that the computer mouse 10 may be removably mounted onto the user's hand. The mounting strap 120 may be connected to an upper portion 130 of the main body 20 such that the main body 20 is subjacent to the user's palm when mounted on the user's hand. Alternatively, the mounting strap 120 may be connected to a lower portion 140 of the main body 20 such that the main body 20 overlies the user's palm when mounted on the user's hand.

In the preferred embodiment, the electrical power source (not shown) is a rechargeable battery (not shown) and the computer mouse 10 includes a charger connection 150 mounted in the main body 20, for connection to a battery charger (not shown). In the preferred embodiment, the charger connection 150 is mounted in the tail section 160 of the main body 20.

In this patent document, the word “comprising” is used in its non-limiting sense to mean that items following that word are included, but items not specifically mentioned are not excluded. A reference to an element by the indefinite article “a” does not exclude the possibility that more than one of the element is present, unless the context clearly requires that there be one and only one such element.

It will be readily seen by those skilled in the art that various modifications of the present invention may be devised without departing from the essential concept of the invention, and all such modifications are intended to be included in the scope of the claims appended hereto.

The embodiments of the invention in which an exclusive property or privilege is claimed are defined as follows:

1. A computer mouse comprising:
(a) a main body having a head section and a tail section, said head section and tail section being articulatably interconnected;
(b) control elements including cursor control means and one or more switches, said cursor control means and one or more switches being mounted in association with the main body;
(c) electronic circuitry electrically connected to the control elements, said electronic circuitry including means for generating input signals corresponding to manipulations of the control elements;
(d) signal transmission means, for transmitting the input signals to a computer; and
(e) an electrical power source.

2. The computer mouse of claim 1, wherein the head section is swivellable relative to the tail section about a longitudinal axis of the tail section.

3. The computer mouse of claim 1, wherein the head section may be articulated about two axes relative to the tail section.

4. The computer mouse of claim 1, wherein the cursor control element and the one or more switches are mounted in association with the head section of the main body.

5. The computer mouse of claim 1, further comprising a mounting strap connected to the main body, said mounting strap being adapted for receiving at least one digit of a user's hand, such that the user interface may be removably mounted onto the user's hand.

6. A computer mouse comprising:
(a) a main body;
(b) a mounting strap connected to the main body, said mounting strap being adapted for receiving at least one digit of a user's hand, such that the user interface may be removably mounted onto the user's hand;
(c) control elements including cursor control means and one or more switches, said cursor control means and one or more switches being mounted in association with the main body;
(d) electronic circuitry electrically connected to the control elements, said electronic circuitry including means for generating input signals corresponding to manipulations of the control elements;
(e) signal transmission means, for transmitting the input signals to the computer; and
(f) an electrical power source.

7. The computer mouse of claim 6, wherein the mounting strap is connected to the main body such that the main body will underlie the user's palm when the device is mounted on the user's hand with the palm down.

8. The computer mouse of claim 6, wherein the mounting strap is connected to the main body such that the main body will overlie the user's palm when the device is mounted on the user's hand with the palm down.

9. The computer mouse of claim 1, wherein one of the one or more switches is an “enter” switch having the function of the “left click” button on a conventional computer mouse.

10. The computer mouse of claim 1, wherein one of the one or more switches is a “right click” switch having the function of a “right click” button on a conventional computer mouse.

11. The computer mouse of claim 1, wherein one of the one or more switches is a “double click” switch which may be clicked once to generate a signal corresponding to a double “left click” of a conventional computer mouse.

12. The computer mouse of claim 1, wherein the control elements further include a scroll wheel mounted on the main body.

13. The computer mouse of claim 1, wherein the control elements further include a touch screen display.

14. The computer mouse of claim 1, wherein the signal transmission means is a hardwired connection from the electronic circuitry to the computer.

15. The computer mouse of claim 1, wherein the signal transmission means comprises a wireless transmitter, for transmitting input signals to the computer.

16. The computer mouse of claim 15, wherein the wireless transmitter is capable of transmitting signals in a frequency spectrum selected from the group consisting of radio waves, microwave waves, and infrared waves.

17. The computer mouse of claim 1, wherein the electrical power source is supplied through a connection to the computer.

18. The computer mouse of claim 1, wherein the electrical power source is a battery.

19. The computer mouse of claim 18, wherein the battery is rechargeable, and wherein the user interface includes a charger connection mounted in the main body, for connection to a battery charger.

20. The computer mouse of claim 19, further comprising a junction box having a plurality of mouse ports and a connection to a mouse port on the computer, wherein the junction box allows more than one computer mouse to be used in conjunction with each other for controlling the same cursor control and the switch functions.
